(19) United States
(12) Patent Application Publication
(10) Pub. No.: US 2009/0246346 A1
(43) Pub. Date: Oct. 1, 2009

(54) Aerated Frozen Desserts Comprising More Than Eighty Percent Tofu Puree

(76) Inventor: Kai-kong Ng, Toronto (CA)

Correspondence Address: Kai-kong Ng, 39 Yatesbury Road, Toronto, ON, M2H 1G1, omitted

(21) Appl. No.: 12/058,668

(22) Filed: Mar. 29, 2008

(51) Int. Cl. A23G 9/38; A23G 9/46

(52) U.S. Cl. 426/565

(57) ABSTRACT

The frozen desserts include aerated “ice-cream-like” frozen desserts, comprising more than 80.0 percent, preferably 80.5 to 87.1 percent, by weight of tofu puree, containing particles. Such frozen desserts include, but are not limited to, products that contain, per 100 grams of product, 3 grams or less of fat, 130 or fewer Calories, 140 milligrams or less of sodium, 300 milligrams or more of calcium, 1 gram or less of saturated fat, 20 milligrams or less of cholesterol, and/or 5 grams or more of soy protein without additionally requiring the use of isolated soy protein or any other soy-protein-containing material.

### CROSS-REFERENCE TO RELATED APPLICATIONS

N/A

### BACKGROUND OF THE INVENTION

### Definitions

In the relevant context of this invention, tofu means the soft, custard-like or cheese-like soybean curd derived from the coagulation of soymilk with a coagulant or combination of coagulants, with or without the separation of whey. Tofu includes, in customary commercial terms used in North America, tofu varieties described as, but not limited to, unpressed custard-like varieties such as extra soft and regular silken tofu, and egg tofu; pressed cheese-like varieties such as soft tofu, medium firm tofu, firm tofu, and extra firm tofu; and light, reduced-calorie, reduced-fat, low-fat, more-protein, high-protein, mild, flavored, and fortified variations thereof; or any hybrid variety thereof; whether produced from non-genetically-modified soybeans, genetically-modified soybeans, organic soybeans, or colored soybeans, or any mixture thereof; and whether produced with or without the addition of any other soybean-derived or protein-containing material at any step of its preparation.

In the relevant context of this invention, tofu puree, or pureed tofu, means the particle-containing, homogenized dispersion of tofu (tofu as defined in the preceding paragraph), whether realized by mechanical, sonic, ultrasonic, or any other effective means of homogenizing dispersion, or combination of means thereof. The quantity of tofu puree in the system is the equivalence of the amount of tofu input to the system before homogenizing dispersion, which operation converts the tofu into tofu puree, containing particles.

In the relevant context of this invention, soymilk means either plain soymilk or formulated soymilk. Plain soymilk means any soy-protein-containing liquid or liquids extracted or reconstituted using water, whether or not involving the use of edible salts, enzymes, alkalis, acids, and/or defoamers, from soybeans or any soybean-derived material or any mixture thereof, or any mixture of such liquids so extracted. Formulated soymilk comprises plain soymilk and one or more added components such as sweetener, fat or oil, protein source, fiber, bulking agent, emulsifier, stabilizer, mineral, vitamin, flavoring, coloring, or any other nutritional or functional ingredient material, whether or not derived from plant sources.

In the relevant context of this invention, coagulant means any material customarily used in coagulating soymilk for tofu preparation, including but not limited to, calcium salts and calcium-containing materials (such as gypsum, calcium sulfate, calcium chloride, calcium acetate, calcium gluconate, calcium lactate, calcium phosphate, and the like), magnesium salts and magnesium-containing materials (such as bittern or nigari, magnesium chloride, magnesium sulfate, and the like), acidulants (such as glucono-delta-lactone, gluconic acid, citric acid, lactic acid, acetic acid, phosphoric acid, malic acid, fumaric acid, and the like), enzymes (such as papain, microbial proteinases, microbial transglutaminases, and the like), or any combination thereof.

In the relevant context of this invention, aerated frozen desserts means any sweetened concoction, frozen or partially frozen after aeration or while being aerated with air or any other gas, served at sub-freezing temperatures, and comprise, for example, frozen desserts including, but not limited to, hardened but scoopable “ice-cream-like” frozen desserts; soft-serve frozen desserts; frozen novelties such as cones, ball top cones, cups, dessert cups, bars, candy bars, sandwiches, sticks, logs, tubes, beads, drops, and any other shaped, molded, extruded, decorated, layered, enrobed, or wrapped varieties; or any combination or composite comprising in part thereof.

In the relevant context of this invention, homogenizing dispersion refers to the unit operation that incorporates one or more immiscible phases into a continuous phase by dispersing action that inputs enough energy to result in a homogenized dispersion in which the separate phases together appear as one visibly-undifferentiated fluid.

In the relevant context of this invention, and throughout the specification and claims, all measures of quantities and percentages are by weight, and temperatures are in degrees Centigrade, unless otherwise stated; and any description or discussion related to a term that appears in singular sense shall also apply to that term in the plural sense, and vice versa.

### FIELD OF THE INVENTION

This invention relates to healthy and enjoyable aerated frozen desserts comprising a high content of over 80.0 percent, or preferably, between 80.5 to 87.1 percent, of tofu puree, containing particles; their method of making; their nutrition-related attributes; and their liking preferences.

### DESCRIPTION OF RELATED ART

Most soy frozen desserts in the marketplace today are made from uncoagulated soymilk, isolated soy protein, or a mixture thereof. To people ordinarily skilled in the art of ice cream, the obvious starting material for a soy-based “ice-cream-like” frozen dessert is soymilk, the equivalent of cow's milk, whether it be plain soymilk or formulated soymilk. This soymilk base is often further combined with a source of fat, a sweetening system, a stabilizer-emulsifier system, a bulking-agent system, and a flavor-characterizing system, before being frozen and packaged like regular ice cream. The advantage of such an approach is simplicity. However, the “ice-cream-like” soy frozen dessert so prepared is low in soy solids. The low solids is partially offset by added fat, but fat adds much to calories. Besides, soy solids are the source of healthy soy components such as heart-healthy soy protein and bioactive soy components. The solids content of soymilk is limited by its tendency to gel at high solids, particularly at high protein, concentration. And isolated soy protein, despite cost savings implications, is associated with an unnatural image and is notorious for its negative flavor impact at high usage levels or on storage. Such limitations and fats-for-solids approach have led to commercial soy frozen desserts exhibiting low soy protein contents and high calories. For example, no commercial soy frozen dessert contains more than 2.5 g soy protein per 100 g, and none, including sugar-free novelties, provides fewer than 135 Calories per 100 g (usually from about 140 to 280 Calories per 100 g). Even in peanut-butter-containing flavors, total protein never exceeds 4 g per 100 g, but then the calories are similar to or higher than that found in regular ice cream, because of the added peanut butter, a source of not only protein but also fat. And disappointing to people looking for truly low-fat treats, no commercial soy frozen dessert contains less than 3 g fat per 100 g. Another limitation in using soymilk or isolated soy protein for making frozen desserts is their susceptibility to a “chalky” mouthfeel when preparing fruit-flavored varieties, such as mango or strawberry, that require a certain degree of acidity to help the fruitiness come through. The low acidity in commercial fruit-flavored soy frozen desserts made with soymilk or isolated soy protein makes the product taste “flat.” Getting up to the desired acidity, however, harshly coagulates the protein to produce gritty “chalkiness.” Such “chalkiness” is unacceptable in frozen desserts.

One possible way to get out of the soymilk and isolated soy protein bind is to start with tofu puree, rather than with plain or formulated soymilk. Tofu puree, or pureed tofu, comes from the homogenized dispersion of tofu, and contains particles. It is such particle-containing nature of tofu puree that discourages people ordinarily skilled in the art of ice cream from considering using it as a starting material for commercial soy frozen desserts, because dairy milk for ice cream is relatively free of discernible particles. Hence high contents of tofu puree is particularly intimidating to most people ordinarily skilled in the art. Coarse particles in soymilk are often associated with the undesirable mouthfeel of “chalkiness,” a defect commonly found even in commercial soymilks where the okara (insoluble fibrous soybean residue) is inadequately clarified from the soymilk, or where calcium fortification is improperly done so that insoluble calcium salts come across as a “chalky” sediment. But if the “chalkiness” issue can be overcome by effective and adequate particle-size reduction, a high content of tofu puree, as replacement for soymilk in soy frozen desserts, brings forth the opportunity of higher soy solids, including heart-healthy soy protein and bioactive soy compounds, lower inclusion of fat and hence fewer calories, higher flavor stability, and better compatibility with fruity acidity, for the realization of truly healthy and enjoyable treats.

Aerated frozen desserts comprising tofu puree, at contents below or up to 80%, is not new. In commercially available Tofutti® frozen dessert products (Tofutti® is registered trademark of Tofutti Brands, Inc., Cranford, N.J.), tofu has been part of their recipe at low levels of inclusion, but then was gradually replaced and quantitatively overtaken by isolated soy protein. For example, in the ingredient lists of today's Tofutti® frozen desserts, tofu is often listed at most the sixth highest, behind “Water, Sugar, Corn Oil, Corn Syrup Solids, and Soy Protein.” And a brief review of prior art has brought at least the following publications to light:
(1) Taketsuka, M. 2006. “Frozen desserts comprising tofu puree.” U.S. Patent Application 20070231440, filed Oct. 6, 2006, published Oct. 4, 2007. (Covers frozen desserts comprising 20% to 80% of tofu puree in the final dessert product composition. This application has also included a discussion of prior art conducted in Japan, which will not be reiterated here.)
(2) Greenberg, P. 2000. “Soy Desserts.” Harper Collins Publishers Inc., New York, N.Y., p. 150-151. (p. 150 covers soy ice cream containing approximately 56% of pureed tofu in the final dessert, and p. 151 covers soy ice cream containing approximately 44% of pureed tofu in the final dessert.)
(3) Schafer, E., and Miller, J. L. 1998. “Vegetable Desserts—Beyond Carrot Cake & Pumpkin Pie.” Chronimed Publishing, Minneapolis, Minn., p. 16. (Covers tofu frozen dessert containing approximately 33% of pureed tofu in the final dessert.)
(4) Williamson, K. B. 1991. “The Taming of Tofu.” Pacific Press Publishing Association, Nampa, Id., p. 96. (Covers tofu ice cream containing approximately 60% of pureed tofu in the final dessert, and tofu ice milk containing approximately 21% of pureed tofu in the final dessert.)
(5) Gregory, M., and Mogi, Y. 1990. “Cooking Japanese Style.” Martin Books, Cambridge, England, p. 106. (Covers tofu ice cream containing approximately 20% of pureed tofu in the final dessert.)
(6) Hagler, L. 1982. “Tofu Cookery.” The Book Publishing Co., Summertown, Tenn., p. 153. (Covers tofu ice creams containing approximately 27% to 45% pureed tofu in the final dessert.)

The prior art brought to light teaches mainly, by common sense, the pureeing of tofu for making frozen desserts, but it does not cover frozen desserts comprising more than eighty percent of tofu puree in the final dessert product composition. The higher content of tofu puree permits the creation of a composition higher in natural soy protein and other bioactive soy components beneficial to health, and it increases the proportion of the low-glycemic soybean component in the composition that permits the creation of low-glycemic frozen desserts for helping satiety, type-2 diabetes, and weight control. The benefits of soy protein, bioactive soy components, and low-glycemic diets are supported by numerous recent research articles. A brief list would include:
(1) Khaodhiar, L., Ricciotti, H., Li, L., Pan, W., Schickel, M., Zhou, J., and Blackburn, G. 2008. “Daidzein-rich isoflavone aglycones are potentially effective in reducing hot flashes in menopausal women.” Menopause. 15(1): 125-134.
(2) Ma, D. F., Qin, L. Q., Wang, P. Y., and Katoh, R. 2008. “Soy isoflavone intake inhibits bone resorption and stimulates bone formation in menopausal women: Meta-analysis of randomized controlled trials.” European Journal of Clinical Nutrition. 62(2): 155-161.
(3) Si, H., and Liu, D. 2008. “Genistein, a soy phytoestrogen, upregulates the expression of human endothelial nitric oxide synthase and lowers blood pressure in spontaneously hypertensive rats.” Journal of Nutrition. 138(2): 297-304.
(4) Song, Y. J., Paik, H. Y., and Joung, H. 2008. “Soybean and soy isoflavone intake indicate a positive change in bone mineral density for 2 years in young Korean women.” Nutrition Research. 28(1): 25-30.
(5) Villegas, R., Gao, Y. T., Yang, G., Li, H. L., Elasy, T. A., Zheng W., and Shu, X. 2008. “Legume and soy food intake and the incidence of type 2 diabetes in the Shanghai Women's Health Study.” American Journal of Clinical Nutrition. 87(1): 162-167.
(6) Azadbakht, L., Kimiagar, M., Mehrabi, Y., Esmaillzadeh, A., Padyab, M., Hu, F. B., and Willett, W. C. 2007. “Soy inclusion in the diet improves features of the metabolic syndrome: A randomized crossover study in postmenopausal women.” American Journal of Clinical Nutrition. 85(3): 735-741.
(7) Chiu, C. J., Milton, R. C., Gensler, G., and Taylor, A. 2007. “Association between dietary glycemic index and age-related macular degeneration in nondiabetic participants in the Age-Related Eye Disease Study.” American Journal of Clinical Nutrition. 8(1): 180-188.
(8) Cho, S. J., Juillerat, M. A., and Lee, C. H. 2007. “Cholesterol lowering mechanism of soybean protein hydrolysate.” Journal of Agricultural and Food Chemistry. 55(26): 10599-10604.
(9) Lampe, J. W., Nishino, Y., Ray, R. M., Wu, C., Li, W., Lin, M. G., Gao, D. L., Hu, Y., Shannon, J., Stalsberg, H., Porter, P. L., Frankenfeld, C. L., Wahala, K., and Thomas, D. B. 2007. “Plasma isoflavones and fibrocystic breast conditions and breast cancer among women in Shanghai, China.” Cancer Epidemiology Biomarkers & Prevention. 16(12): 2579-2586.
(10) Nagata, Y., Sonoda, T., Mori, M., Miyanaga, N., Okumura, K., Goto, K., Naito, S., Fujimoto, K., Hirao, Y., Takahashi, A., Tsukamoto T., and Akaza, H. 2007. “Dietary isoflavones may protect against prostate cancer in Japanese men.” Journal of Nutrition. 137(8): 1974-1979.
(11) Sites, C. K., Cooper, B. C., Toth, M. J., Gastaldelli, A., Arabshahi, A., and Barnes, S. 2007. “Effect of a daily supplement of soy protein on body composition and inulin secretion in postmenopausal women.” Fertility and Sterility. 88(6): 1609-1617.
(12) Taku, K., Umegaki, K., Sato, Y., Taki, Y., Endoh, K., and Watanabe, S. 2007. “Soy isoflavones lower serum total and LDL cholesterol in humans: A meta-analysis of 11 randomized controlled trials.” American Journal of Clinical Nutrition. 85(4): 1148-1156.
(13) McMillan-Price, J., Petocz, P., Atkinson, F., O'Neill, K., Samman, S., Steinbeck, K., Caterson, I., and Brand-Miller, J. 2006. “Comparison of 4 diets of varying glycemic load on weight loss and cardiovascular risk reduction in overweight and obese young adults: A randomized controlled trial.” Archives of Internal Medicine. 166(14): 1466-1475.

In Taketsuka's patent application, his rejection of frozen dessert compositions comprising more than 80% tofu puree appeared to be the result of inadequate experimental design. He accepted the frozen dessert composition comprising 80% tofu puree but rejected the composition comprising 90% tofu puree, and ignored any viable possibility in-between that could turn out to be optimal. He also emphasized preferences in the context of the Japanese market, such as beating minimum fat contents to qualify the products as “ice creams” and not “sherbets.” In so doing he has ignored opportunities such as low-fat, reduced-calorie, and good-protein-source possibilities. In fact, this invention has capitalized on the window of opportunity for nutritionally superior and organoleptically enjoyable frozen desserts with composition comprising more than eighty percent tofu puree, and incorporating nutritional benefits such as low-fat, reduced-calorie, good-protein-source, low-cholesterol, low-saturated-fat, low-sodium, and calcium-enriched. Most of these are certainly highly-relevant attributes in a world focused on the negative health implications of excessive fat, sugar, and salt in people's diet. And one reason why I can discover this window of opportunity is because I have been working on frozen desserts comprising tofu puree since 1996, have since been marketing in Canada a frozen dessert comprising 50% tofu puree. However, the product was not considered patentable because then published prior art already covered frozen desserts comprising up to 60% tofu puree. All along I have been trying to design a patentable aerated frozen dessert composition comprising the highest content of tofu puree for nutritional and functional superiority and yet compatible with physical enjoyability and processing practicability. Now that the desired product is finally realized, by a process which is commercially scaleable, and the publication of Taketsuka's Application has prompted a viable window of opportunity, I have taken that opportunity to apply for patentability of this invention.

In addition, in Taketsuka's Application, his rejection of frozen dessert compositions comprising more than 80% tofu puree was based once again on criteria more relevant to the Japanese market, or more specifically, to the Japanese frozen novelties market in their summer season. Whereas, in the North American market, the same criteria may not apply, or more specifically, Taketsuka's criteria of frozen dessert shape retention and drip resistance (very slow meltdown) may be contrary to criteria advocated by frozen-dessert experts in North America.

In Taketsuka's Application, under DESCRIPTION OF THE RELATED ART, in BACKGROUND OF THE INVENTION, para. 20 says

“For a frozen dessert, the texture (smoothness in the mouth) and flavor are important. Moreover, drip resistance (which is a characteristic such that the dessert hardly melts even when the temperature rises) and shape retainability (which is a characteristic to retain an original shape even after melting begins) are particularly important for a frozen dessert. The reason for this is that theme parks and convenience stores have recently become accessible, and so the opportunity for eating outdoors has increased, particularly the opportunity for eating frozen desserts at high temperature in summer has increased.”
And para. 21 says:
“However, the frozen desserts disclosed in the above-mentioned Patent Documents 5 to 9 lack the drip resistance and shape retainability and do not satisfy demands of the consumer.” where Patent Documents 5 to 9 refer to frozen desserts comprising tofu puree, that melt like regular ice cream.

Professor Wendell Sherwood Arbuckle, formerly of the Department of Dairy Science of the University of Maryland, was the most respected authority in ice cream. He authored four editions of “Ice Cream”, the latest of which was published in 1986, which is still recognized today as a classic introduction to the science of ice cream making. In his 4^{th} edition of “Ice Cream,” (hereinafter referred to as Arbuckle's book), on page 322, he elaborated on the MELTING QUALITY DEFECTS of frozen desserts as follows:

“Desirable melting qualities are shown when the melted ice cream is very similar in characteristic to that of the original mix . . . . “Does not melt” includes not only ice cream that retains its shape when warmed but also the various degrees of slow melting to a liquid. It frequently accompanies body defects such as “soggy,” “gummy,” “doughy,” and “sticky.” The conditions causing these body defects also contribute to high melting resistance. Other factors producing this melting defect include a high fat content, drawing at a low temperature from continuous freezers, high freezing point, and excessive viscosity resulting from slow cooling, the use of calcium neutralizers, or certain types of stabilizers . . . . Slow melting indicates overstabilization or improper processing of the mix. The condition can be corrected by reducing the amount of stabilizer or emulsifier, using fresh dairy products, or homogenizing at proper temperature or pressure.”

With my prior experience in frozen desserts comprising tofu puree, I can deduce from the foregoing, though it may not be readily apparent to or technically realizable by someone ordinarily skilled in the art in a related area, that a window of opportunity exists for healthy and enjoyable frozen desserts comprising principally of tofu puree more than eighty percent by weight. However, such a frozen dessert system requires other components in addition to tofu puree. According to Arbuckle, on page 1 of his book, “Ice cream and related products are generally classified as frozen desserts, which include ice cream, frozen custard, ice milk, sherbet, water ice, frozen confections, and mellorine- and parevine-type products . . . . The composition of ice cream varies in different markets and different localities. The composition for good average ice cream is fat, 12%; milk solids not fat (MSNF), 11%; sugar, 15%; stabilizer and emulsifier, 0.3%; and TS, 38.3% . . . . The physical structure of ice cream is a complicated physiochemical system. Air cells are dispersed in a continuous liquid phase with embedded ice crystals. The liquid phase also contains solidified fat globules, milk proteins, insoluble salts, lactose crystals in some cases, stabilizers of colloidal dimension, and sugars and soluble salts in solution. The finished product consists of liquid, air, and solid, and constitutes a three-phase system.” Of course, in a parevine-type product in which no dairy ingredients are used, the milk fat, milk proteins, and lactose are replaced by ingredients of non-dairy origin, and in diabetic products, sugars are replaced by sugar substitutes. Although Arbuckle mentioned only, on page 285 of his book, that “Sugar substitutes for diabetic frozen dairy foods include hexahydric alcohols (classified as sugar alcohols), sucaryl (sodium and calcium), and saccharine,” he had the foresight to include, on page 83 of his book, “bulking agents, polydextrose, cellulose, malto dextrins, aspartame, and other high-intensity sweeteners” in his discussion on “Functional Ingredients.” Hence a sweetener component and a stabilizer-emulsifier component are integral to any frozen dessert system. To be described as a dessert, the product must taste sweet; to function as an “ice-cream-like” frozen dessert, it must be scoopable like ice cream at the temperature of dipping cabinets (−10 to −15° C.), meaning that it must have a freezing-point depressing component, which often is part of the sweetener system; to have a shelf-stable architecture of the frozen foam, it needs a stabilizer-emulsifier component to stabilize the system against temperature shocks throughout storage and distribution; and in any frozen dessert system where sugar or fat is replaced by low-bulk substitutes, like in diabetic or dietetic compositions, bulking agents are often needed. To anyone ordinarily skilled in the art, these are commonsense technical requirements.

It therefore came as a surprise that such basic and obvious technical requirements could form the basis of claims of U.S. Patent Application No. 20060286248 filed by Anfinsen and Tungland, titled “Reduced-carbohydrate and nutritionally-enhanced frozen desserts and other food products.” Given that Anfinsen and Tungland's application has been filed for over three years since Oct. 4, 2004, was ultimately published on Dec. 21, 2006, and yet superficially no patent has been granted to-date, I shall presume that their claimed invention is not patentable because the composition claimed is obvious to a person ordinarily skilled in the technology related to the field of the invention.

Anfinsen and Tungland stated in the Abstract of their patent application: “A reduced carbohydrate ice cream or other frozen dessert product that contains a low-digestible sweetener system and a fermentable fiber material. The low-digestible sweetener system consists of one or more low-digestible sweeteners having a molecular weight of from about 90 to about 190; and is typically a low molecular weight saccharide or a polyol. Typical low-digestible sweeteners include mannitol, maltitol, sorbitol, lactitol, erythritol, xylitol, isomalt, glycerin, talitol, mannose, tagatose, fructose, arabinose, fucose, lycose, ribose, sorbose, talose, and xylose, and mixtures thereof. The low-digestible sweetener replaces the digestible sugars to provide the appropriate freezing point depression of the product. The level of fermentable fiber is sufficient to mitigate a laxation effect that can be caused by ingestion of the amount of the low-digestive sweetener. The fermentable fiber can be an inulin, a maltodextrin resistant to human digestion, an oligofructose, a fructooligosaccharide, a high water binding fermentable fiber, and a mixture thereof.”

However, the applicants admitted in their SUMMARY OF THE INVENTION, in their para. 46, that “The fermentable fiber material can be selected from the group consisting of inulin; a maltodextrin resistant to human digestion; an oligofructose or fructooligosaccharide (FOS) (also referred to as a neosugar); polydextrose; a high water binding fermentable fiber; and a mixture thereof . . . . A high water binding fermentable fiber includes a hydrocolloid selected from xanthan gum, guar gum, pectin (low methoxyl), pectin (high methoxyl), alginate, carrageenan, locust bean gum, tragacanth gum, karaya gum, konjac flour mannan, glucan, and tamarind gum.”
And in their para. 58, “By comparison, typical conventional frozen desserts employ sweeteners that are high in digestible carbohydrates. Common sweeteners used in frozen desserts include, sugar, corn syrup, high fructose corn syrup, fructose, glucose, lactose, honey, molasses, maltose, and sugar alcohols (maltitol, maltitol syrups, sorbitol, isomalt, lactitol, erythritol, and xylitol).”

Given that the applicants Anfinsen and Tungland have admitted that common sweeteners used in frozen desserts include such “slow-digestible” sweeteners like fructose and sugar alcohols (polyols) mentioned in their Claims; given that common stabilizers used in frozen desserts are mostly high water binding fermentable fibers like guar gum, locust bean gum, and carrageenan, as described by Arbuckle on page 85 of his book and widely practiced in the trade, at common usage levels within the range prescribed by the applicants; and given that common bulking agents used in frozen desserts, particularly those formulated for special dietary needs, such as reduced fat or reduced sugar, include “an inulin, a maltodextrin resistant to human digestion, an oligofructose, a fructooligosaccharide, a high water binding fermentable fiber, and a mixture thereof,” as prescribed by the applicants, the applicants' claim of composition is not uniquely new and is therefore inconsistent with the patent requirement that the patentable invention must not be obvious to those ordinarily skilled in the art to which the subject matter pertains. A brief list of prior art describing compositions pre-empting the applicants' claim of composition includes:
(1) Guo, P. 2004. “Herbal sweetening composition.” United States Patent Application 20040058050, filed Mar. 25, 2004.
(2) Gare, F. 2007. “Composition containing xylitol and fiber.” U.S. Pat. No. 7,182,968, filed Jan. 11, 2001, issued Feb. 27, 2007.
(3) Fukinbara, I., Watanabe, N., Tohi, S., and Okada, N. 2005. “Dehydrated frozen confections.” U.S. Pat. No. 6,916,498, filed Oct. 24, 2002, issued Jul. 12, 2005.
(4) Wolkstein, M. 1986. “Dietetic frozen desserts containing aspartame.” U.S. Pat. No. 4,626,441, filed Oct. 6, 1983, issued Dec. 2, 1986.
(5) Morley, R. G., and Ashton, W. R. 1983. “Dietetic frozen dessert food.” U.S. Pat. No. 4,400,405, filed Jan. 26, 1981, issued Aug. 23, 1983.

I shall therefore include, in describing Examples of my composition for frozen desserts comprising tofu puree, a sweetener system, a stabilizer-emulsifier system, and a bulking agent system, as commonly practiced in the art related to my field of invention, particularly for products formulated for special dietary needs such as reduced fat or reduced sugar, on the assumption that the Claims stated in Anfinsen and Tungland's published patent application could not hold up to being proprietary. While a patent shall be presumed valid, a patent application like that filed by Anfinsen and Tungland may not necessarily be so. In the unlikely event that Anfinsen and Tungland were eventually granted a patent on their aforesaid patent application, I could still choose from the very limited remaining alternatives that, in combination, would not contravene the Claims in Anfinsen and Tungland's patent application. In any event, these adjunct sweetener, stabilizer-emulsifier, and bulking-agent systems do not form part of my Claims in this invention, but they will serve the purpose of contributing to illustrative Examples in the subsequent section on “DETAILED DESCRIPTION OF THE INVENTION.” It must be understood, however, that the Examples, with descriptions of ingredients and proportions, and processing equipment and conditions, serve to further illustrate the present invention in detail but are not to be construed to limit the scope thereof.

### BRIEF SUMMARY OF THE INVENTION

### Object of this Invention

The object of this invention is to create healthy and enjoyable aerated “ice-cream-like” frozen desserts comprising more than eighty percent tofu puree; which desserts contain no added fat or oil, and no added high-glycemic sugar, other than that which is an integral part of an adjunct flavor-characterizing ingredient, such as cocoa, nut, or fruit; which desserts are reduced in calorie (calories per reference amount reduced by 25% or more compared with reference product); which desserts are low in sodium (140 mg or less per 100 g product), and enriched with calcium to more than 30% of daily value per reference serving (300 mg or more per 100 g product); which desserts are low in saturated fat (1 g or less per 100 g product, and no more than 15% of calories from saturated fat), and low in cholesterol (20 mg or less per 100 g product); which desserts qualify as low-fat by having 3 g or less fat per 100 g product, and 30% or less of total calories are derived from fat; and which desserts also qualify as a good source of protein by having 5 g or more protein per 100 g product, without additionally requiring the use of isolated soy protein or any other soy-protein-containing material.

As set forth in the DEFINITIONS and discussed in the DESCRIPTION OF RELATED ART, tofu, being derived from the coagulation of soymilk, must be converted into tofu puree, with concomitant particle-size reduction, in the preparation of aerated “ice-cream-like” frozen desserts. To achieve the highest contents of natural soy protein, bioactive soy compounds, and low-glycemic soy components commensurate with a healthy and enjoyable frozen dessert comprising tofu puree, I have succeeded in arriving at aerated compositions containing more than 80.0% tofu puree, and preferably, about 80.5% to 87.1%, surpassing the expected ceiling of 80.0% tofu puree in a frozen dessert as previously described by Taketsuka.

Because the frozen desserts comprise a very high content of tofu puree, itself a good source of natural soy protein, it is now possible to create compositions that contain 5 g or more protein per 100 g of product, meeting both American and Canadian official definitions of a good source of protein. And given that the U.S. FDA, since 1999, has recognized that a daily intake of 25 g soy protein, combined with a diet low in saturated fat and dietary cholesterol, may reduce the risk of heart disease, the 5 g soy protein per 100 g in the present invention is a meaningful contribution toward that 25 g targeted daily intake for reducing heart disease risk.

Because foods which meet the FDA definition of heart-healthy soy-protein foods must be low in fat (less than 3 g), saturated fat (less than 1 g), cholesterol (less than 20 mg), and sodium (less than 480 mg) per serving, the present invention is designed with meeting or beating such requirements in mind.

Unlike Taketsuka's patent application, no extraneous fat or oil, except for that which is an integral part of adjunct flavor-characterizing materials such as cocoa, nuts, or fruits, is used in the present invention, in order to achieve a low-fat composition comprising less than 3 g fat per 100 g product. This is made possible by homogenizing-dispersing the tofu to tofu puree particles that are between 0.1 to about 27 μm in size to mimic the functionality of fat in a frozen dessert. The higher tofu puree content also adds bulk from the soy proteins and soluble fibers inherent in the tofu puree, to help replace the bulk of fat foregone. And because no extraneous fat or oil is used in the present low-fat invention, and the soy oil inherent in the tofu puree comprises only 15% saturated fat, the final composition contains less than 1 g saturated fat per 100 g product, even in cocoa-based flavors such as Chocolate or Chocolate Mint. The low-fat approach also permits the realization of a reduced-calorie composition because fat adds the most calories at 9 Calories per gram, compared with 4 Calories per gram from either protein or carbohydrate.

The present invention is also designed to be a low-sodium product, defined in U.S. and Canada as products containing 140 mg or less of sodium per reference amount, say in 100 g.

In view that tofu is not particularly high in calcium, and to make up for the disadvantage against dairy counterparts, it is desirable to enrich the frozen desserts of the present invention with calcium using calcium sources such as calcium citrate, calcium lactate, calcium gluconate, calcium lactate gluconate, or the like, up to about 30% of the daily value, at about 300 mg per reference amount, say in 100 g.

To complete the composition of frozen desserts comprising principally of tofu puree, I have employed, as per Arbuckle's teachings, a sweetener system, with freezing-point depressing capability, comprising saccharides such as fructose, tagatose, and the like, and/or sugar polyols such as xylitol, erythritol, glycerol, and the like, with or without high-intensity sweeteners such as sucralose, and the like, or mixture thereof; a stabilizer system, comprising hydrocolloids, such as guar gum, locust bean gum, carrageenan, microcrystalline cellulose, carboxymethylcellulose, and the like, or mixture thereof; an emulsifer system, comprising emulsifiers, such as mono- and di-glycerides, lecithin, and the like, or mixture thereof; and a bulking-agent system comprising soluble filler materials, such as inulin, oligofructose, polydextrose, maltodextrins, resistant starches, and the like, or mixture thereof.

In the present invention, the preparation of frozen desserts typically comprises the following generic steps, involving processing equipment and conditions described hereafter (in the section on DETAILED DESCRIPTION OF THE INVENTION):
(1) “Coarse” homogenizing dispersion of tofu, including other pre-weighed base ingredients, to yield coarse mash comprising principally of tofu puree;
(2) Pasteurization or sterilization of coarse mash;
(3) Cooling of pasteurized or sterilized coarse mash;
(4) Aging of pasteurized or sterilized coarse mash;
(5) “Fine” homogenizing dispersion for particle-size reduction of aged coarse mash to base mix;
(6) Finishing by adding flavoring(s), acidulant(s), or coloring(s), or mixture thereof, to convert base mix to finished mix, if necessary; and
(7) Freezing of finished mix with aeration to achieve an “ice-cream-like” texture with overrun, adding mix-ins or bulk inclusions where desired; and soft-serving the product without hardening, for immediate consumption on-premise; or packaging and hardening the product for subsequent storage, distribution, and consumption.

In the steps described in the preceding paragraph, the base mix after step (5) or the finished mix after step (6) may be packaged for refrigerated or frozen storage for distribution elsewhere for subsequent finishing, and/or aerated freezing, for making “ice-cream-like” hardened frozen desserts, soft-serves, or frozen novelties.

In creating aerated frozen desserts comprising tofu puree, I have differentiated from Taketsuka's approach by de-emphasizing shape-retention and slow-melting, both of which may fit the preference of some Japanese consumers for frozen novelties, but which run counter to normal North American preference for ice cream, as unambiguously described by Arbuckle. My choice of composition therefore differentiates from Taketsuka's, not only based on the higher content of tofu puree, but also based on avoiding the undesirable meltdown characteristics resulting from a high fat content, over-emulsification, or over-stabilization, while achieving the object of realizing a healthy and enjoyable frozen dessert comprising principally of tofu puree, to yield a functional, low-fat, reduced-calorie, good-protein-source, low-sodium, calcium-enriched, and satisfying treat containing a high content of natural soy protein, bioactive soy compounds, and low-glycemic soy components.

In my choice of ingredients to complement tofu puree in a frozen dessert system, I prefer to use materials that are natural and organic as far as possible.

I also prefer to use materials of non-animal origin so that the final compositions will be cholesterol-free and will meet vegan-vegetarian requirements. Such preference can be relaxed if no aforesaid constraints are imposed, but in any event the cholesterol content shall be kept below 20 mg per serving, to stay within the FDA definition of heart-healthy soy-protein foods.

To make products of this invention even healthier than a very high tofu puree content alone, I prefer to choose characterizing ingredients that not only contribute a distinct and familiar flavor character, but also functional health benefits. Examples include, but are not limited to, green tea, dark cocoa, almonds, blueberries, and strawberries, some of which will appear in Examples in the later section on “DETAILED DESCRIPTION OF THE INVENTION.” Products of this invention can also be used as carriers of enriching nutrients, such as minerals like calcium as mentioned earlier, and vitamins like calciferols, and functional nutraceuticals, such as omega-3 fatty acids like docosahexenoic acid and eicosapentenoic acid, and carotenoids like lutein, astaxanthin, and zeaxanthin. The list of possible enriching agents, functional supplements, and synergistic combinations thereof is almost unlimited.

For the purpose of this invention, I prefer ingredients that belong to the “low-glycemic-index” or “low-GI” category, having GI values equal to or below 55, or preferably equal to or below 40, compared to GI values like glucose reference at 100, sucrose at 68, and regular ice cream at 61. The slower and lower spike of blood glucose upon ingestion of the low-GI food minimizes inulin swings, thus helping to control appetite through satiety, reduce arterial inflammation and fat storage, and ease the stress on the pancreas and kidney. For example, the soybean has a GI value of 15; fruits like strawberries and blueberries have a GI value of 40; nuts like almonds have a GI value of 22; fermentable fibers like inulin has a GI value of 4, and polydextrose has a GI value of less than 7; low-GI sweeteners like fructose has a GI value of 22, xylitol has a GI value of 7, erythritol and glycerol have GI values close to zero, and high-intensity sweeteners like sucralose have GI values practically equal to zero too.

Besides being low-GI, the soybean and soybean products like tofu and soymilk are super foods in multiple aspects. In addition to being a good source of heart-protective soy protein, they are also good sources of functional bioactive compounds like isoflavones that benefit protection against breast cancer, osteoporosis and postmenopausal symptoms; like lunasin that helps protection against prostate cancer; like saponins that help reduce the absorption of dietary cholesterol; and like soluble fibers that act as prebiotics in nurturing healthy bowels. These super food attributes have been reported in numerous articles of scientific research, of which some of the most recent ones were included in the brief list in paragraph [0012].

This present invention does not only benefit people concerned about body weight and type-2 diabetes, but also facilitate the adoption of a healthy lifestyle, by young people in particular. Researchers from the UK, in a study funded by the British Heart Foundation, have identified some of the main barriers to young people adopting a healthy lifestyle, including the cost of healthy foods, hunger satisfaction, taste, and peer pressure. The researchers found that when children had limited money to spend on food, they were resistant to trying new products, sticking instead to time-honored snack favorites. In addition, they saw less healthy options, like chips, as being better able to satisfy their hunger than fruit. By this invention of healthy frozen desserts which are “ice-cream-like” in familiar product format and flavor variety, I have facilitated their transition to a healthy lifestyle, by providing affordable options that will satisfy their requirements for satiety, taste, and social acceptability. In view that eating habits developed since childhood can strongly influence the future development of serious lifestyle diseases, this invention is meant to be part of an integrated effort to help people live a more productive life of higher quality. Citation for the UK study is: Khunti, K., Stone, M. A., Bankart, J., Sinfield, P., Pancholi, A., Walker, S., Talbot, D., Farooqi, A., and Davies, M. J. 2008. “Primary prevention of type-2 diabetes and heart disease: action research in secondary schools serving an ethnically diverse UK population.” Journal of Public Health. 30(1): 30-37.

The invention described herein complements existing knowledge of frozen desserts made from tofu puree by filling in the vacuum of prior art. This forms the basis of patentability. This invention fills the void of practical realities and provides hitherto unprecedented and undisclosed method and composition with attributes meaningful to a new world beset with lifestyle diseases, including but not limited to obesity, diabetes, fatty liver, metabolic syndrome, heart disease, and various forms of cancer. Our food environment, radically changed over the past 100 years or so, is impacting our health in a way that our genetic adaptation has been outpaced. Our inherited “thrift” or “fat” genes, by regulating hormones, govern our accumulation of body fat when caloric intake exceeds expenditure so that humans, like our Stone-Age ancestors, may survive lean times when food supply is scarce. But nowadays with food in relatively inexpensive abundance, this change in food environment has overwhelmed our inborn mechanisms to cope, not unlike the current climate change that is challenging our way of life. People the world over will be better off if only we can modify our food environment to combat obesity and the harms it inflicts upon us. An enjoyable frozen dessert comprising principally of tofu puree is exactly an attempt contributing to changing our food environment for the better. That is a mission that drives the realization of this invention.

### DETAILED DESCRIPTION OF THE INVENTION

Preparation of Soymilk:

A good place to start the detailed description is the preparation of soymilk for making tofu, which when turned into tofu puree by homogenizing dispersion, forms the principal basis of the frozen desserts described herein. It must be remembered, however, that the process for soymilk described here is one benchtop model only. Many variants of soymilk processing have been scaled up for commercial production by process and equipment vendors such as ProSoya Inc. (Ottawa, Ontario, Canada), Takai Tofu & Soymilk Equipment Co. (Ishikawa-ken, Japan), Izumi Food Machinery Co., Ltd. (Hyogo, Japan), and Ta Ti Hsing Machinery Company Ltd. (Taoyuan, Taiwan). Here, soymilk with minimal beany flavor, is prepared by the hot-grinding of soaked soybeans:

### EXAMPLE 1

### Preparation of Soymilk Prior to Tofu Preparation

Dry soybeans, weighing about 200 g, were washed and soaked in water at 25° C. for 6 to 8 hours to about 450 g to 500 g drained weight. Then the soaked beans were drained and ground, with 1.6 g monoglyceride (supplied by Danisco Canada Inc., Scarborough, Ontario, Canada) added as a defoamer, using a Silverson Model L4RT Laboratory Mixer, supplied by Silverson Machines, Inc., East Longmeadow, Mass., and equipped with one-inch disintegrating head, at 5,000 rpm for 5 minutes, with about 1.5 kg of near-boiling water at 95 to 100° C. for lipoxygenase inactivation. The covered hot slurry was kept in a hot water bath for 15 minutes, at 85 to 90° C., for the inactivation of microbes and anti-nutritional factors like trypsin inhibitors. It was then filtered through a cheesecloth bag to remove the insoluble residue, or okara, to obtain the soymilk, which contained about 8.6% soy solids. This soymilk was then ready for making into tofu. It was either cooled to 25 to 30° C. for the preparation of unpressed extra soft silken tofu, or kept at 80 to 85° C. for the preparation of pressed firm tofu.

Preparation of Tofu:

Soymilk must first be turned into tofu, before frozen desserts comprising principally of tofu puree can be prepared, as per the generic steps outlined in paragraph [0030] earlier on. I must emphasize, however, that while I can illustrate this invention with just one variety of tofu, or two or more varieties of tofu working together, I have chosen to illustrate this invention using two varieties of tofu, namely, unpressed extra soft silken tofu and pressed firm tofu. It must be understood that the implementation of this invention is not limited by the choices of these two tofu varieties, because the generic steps herein described will work well with a single, or three or more varieties of tofu together, only the weight ratio of tofu varieties will differ in each case, as obvious to a person skilled in the art. It must also be remembered that the tofu processes described here are benchtop models only, but they share similar principles and bring about similar qualitative coagulative change of soymilk into tofu, as in scaled-up models. In fact, many variants of tofu processing, some made continuous, have been scaled up for commercial production by process and equipment marketers such as Takai Tofu & Soymilk Equipment Co., Izumi Food Machinery Co., Ltd., and Ta Ti Hsing Machinery Company Ltd. In my reasoning, unpressed extra soft silken tofu provides a low-fat and high-moisture base for incorporating other frozen dessert ingredients, while pressed firm tofu contributes the high soy solids and protein for satisfying textural and minimum protein needs. Unlike Taketsuka's patent application, in which he relied on only one single variety of tofu for formulating his frozen desserts, which made composition formulation inflexible, now a mixture of the two kinds of tofu will provide sufficient versatility in meeting operational and nutritional requirements. Tofu, to be processed further into frozen desserts as per generic steps outlined in paragraph [0030], can be made from the prepared soymilk described in Example 1, as follows:

### EXAMPLE 2

### Preparation of Unpressed Extra Soft Silken Tofu from Soymilk

For unpressed extra soft silken tofu, an aqueous mixed-coagulant solution containing 22% glucono-delta-lactone (GDL) and 8% magnesium chloride (both ingredients supplied by Univar Canada Ltd, Weston, Ontario, Canada) was mixed into the cooled soymilk as prepared in Example 1, at a dosage of 1%. The covered mixture was heated in a water bath at 80 to 85° C. for 50 minutes to allow for coagulation to complete. The coagulated extra soft silken tofu, if not used immediately for the preparation of frozen desserts comprising tofu puree, was refrigerated at 1 to 4° C. until later use. This unpressed, custard-like, extra soft silken tofu contained about 8.5% solids, 4.4% protein, 2.1% fat, 1.2% carbohydrate, and 0.9% ash.

### EXAMPLE 3

### Preparation of Pressed Firm Tofu from Soymilk

For pressed firm tofu, the hot soymilk at 80 to 85° C. was poured into a stainless steel container containing an aqueous mixed-coagulant slurry, comprising 20% calcium sulfate, 12% GDL, and 8% magnesium chloride (all three ingredients supplied by Univar Canada Ltd.) and used at 1% of the quantity of soymilk, and mixed by stirring for about 20 to 25 seconds. The mixture was covered and left to stand for about 30 minutes to allow for complete coagulation, after which the curd was broken up and transferred to a stainless steel forming box with drain holes and already lined inside with an oversized cheesecloth with triangular flaps completely overhanging the four sides of the box. After filling the forming box with curd, the overhanging flaps of the cheesecloth were folded across the surface of the curd, and an insert lid befitting the internal dimension of the box was put on top of the curd mass. The curd mass was then subjected to stepwise-increasing mechanical pressure to facilitate curd matting and whey separation, through added weights placed on the lid, initially at 20 g/cm.sub.2 pressure for 10 minutes, then at 40 g/cm.sub.2 for another 10 minutes, and followed by 80 g/cm.sub.2 for an additional 10 minutes. At this point the net weight of the curd corresponded to about half the weight of the soymilk started out with. The pressed firm tofu was then cut into cakes, and, if not used immediately for the preparation of frozen desserts comprising tofu puree, was refrigerated at 1 to 4° C. until later use. This pressed firm tofu contained about 16.5% solids, 8.7% protein, 4.6% fat, 2.4% carbohydrate, and 0.9% ash.

The Generic Steps in the preparation of frozen desserts comprising principally of tofu puree, starting with tofu, are described in the following paragraphs, with Examples. While the invention has been described with reference to the specific embodiment of the Examples, it will be obvious to a person skilled in the art that variations and modifications can be made within the scope of the invention as defined in the Claims.

Generic Step (1): “Coarse” Homogenizing Dispersion of Tofu, Including Other Pre-Weighed Base Ingredients, to Yield Coarse Mash Comprising Principally of Tofu Puree:

For the purpose of this invention, tofu puree is prepared by the homogenizing dispersion of tofu, which is either processed straight after tofu-making, or has been kept fresh at a temperature between 1 and 4° C., prior to the operation. The conversion of tofu to tofu puree may be done independently of adjunct ingredients, which are then added and blended into the tofu puree to yield the coarse mash. Alternatively or more efficiently operation-wise, the adjunct ingredients can be added to the tofu before initiating the first homogenizing dispersion, so that in one single step the adjunct ingredients may be simultaneously combined with the “liquefied” tofu to form the coarse mash, which is comprised principally of tofu puree. The conversion of tofu and adjunct ingredients to coarse tofu-puree mash may be achieved by various means, such as by mechanical, sonic, ultrasonic, or any other means of homogenizing dispersion, or any combination of means thereof, but is preferably done by an “in-tank” mechanical homogenizing-dispersing mechanism employing a device such as the Silverson high shear batch mixer or disintegrator, with a square hole high shear screen, supplied by Silverson Machines, Inc. On a small scale, the Silverson L4RT Laboratory Mixer is the mechanical device of choice, using the square hole high shear screen with 2-mm holes. This powerful mixer assembly, when activated at 1000 rpm or higher, preferably 2000 to 4000 rpm, for 30 seconds or more, preferably for 2 to 6 minutes, is capable of converting tofu into tofu puree, or tofu with adjunct ingredients into coarse tofu puree mash. Such conversion involves changing the tofu from a custard-like or cheese-like consistency to a liquefied, pumpable dispersion of suspended particles. This high shear operation also ensures the proper hydration and dispersion of the adjunct materials in the tofu puree.

For scaling up to commercial production, the preferred mechanical device for this “coarse” first homogenizing dispersion is the Silverson high-shear in-tank top-entry batch mixer equipped with square hole high shear screen, or, even more preferably, the Silverson high-shear in-tank bottom-entry mixer, like the Silverson Disintegrator 2500, equipped with square hole high shear screen, designed to fit into the bottom or side of a mixing vessel, and used in conjunction with a slow speed scraper unit to handle the high viscosity contents. The bottom entry mixer provides high shear homogenization while the scraper distributes the homogenized output uniformly throughout the vessel. Preferably, the system, whether top-entry or bottom-entry, is coupled with a self-pumping high-shear in-line mixer to ensure complete dispersion before downstream operation.

### EXAMPLE 4

### Preparation of Coarse Mash Comprising Principally of Tofu Puree from Tofu and Adjunct Ingredients Designated for Aerated “Ice-Cream-Like” Vanilla-Flavored Frozen Desserts

A mixture of tofu varieties, either straight from tofu-making and still warm, or kept at 1 to 4° C. after cooling, comprising 1.21 kg unpressed extra soft silken tofu, prepared as described in Example 2, and 0.54 kg pressed firm tofu, prepared as described in Example 3, was subjected to high-shear homogenizing dispersion using the Silverson L4RT Laboratory Mixer, equipped with the square hole high shear screen with 2 mm holes, at 3000 rpm for 3 minutes, to reduce it to tofu puree. To this tofu puree was added adjunct ingredients, including 223 g glycerin (96%, supplied by Univar Canada Ltd.), 1.6 g sucralose solution (25%, supplied by Tate & Lyle, Decatur, Ill.), 2.8 g mono- and di-glycerides (supplied by Danisco Canada Inc.), and a dry pre-mix comprising 2.5 g salt, 15.0 g calcium lactate gluconate (supplied by Purac America, Inc., Lincolnshire, Ill.), 2.6 g regular non-resistant maltodextrin (supplied by Univar Canada Ltd.), 2.0 g guar gum (supplied by Univar Canada Ltd.), 1.3 g locust bean gum (supplied by Univar Canada Ltd.), 0.9 g carboxymethylcellulose (supplied by Danisco Canada Inc.), and 0.4 g carrageenan (supplied by Univar Canada Ltd.), and the mixture was subjected to further high-shear homogenizing dispersion at 3000 rpm for an additional 3 minutes, to complete the coarse-mashing step. This high shear operation reduced the tofu in the coarse mash to tofu puree particles, which appeared mostly spheroidal and not exceeding 50 μm in diameter under optical measuring microscopy. The mean particle size, estimated based on Martin's diameter or taken here as the length of the line (in the direction of the horizontal reticle line) dividing the particle area in two equal areas, applied to a total of 625 particles in random fields, was 27 μm. The observation of particle shape and size was made on the spin-dried dispersion on a glass microscope slide, using a Meiji Techno Measuring Microscope MC-40T at 1000 times total magnification with transmitted light from a halogen light source and equipped with an eyepiece micrometer cross-line reticle with 0.1 mm graduations (Meiji Techno America, Santa Clara, Calif.).

### EXAMPLE 5

### Preparation of Coarse Mash Comprising Principally of Tofu Puree from Tofu and Adjunct Ingredients Designated for Aerated “Ice-Cream-Like” Chocolate-Flavored Frozen Desserts

A mixture of tofu, either straight from tofu-making and still warm, or kept at 1 to 4° C. after cooling, comprising 1.12 kg unpressed extra soft silken tofu, prepared as described in Example 2, and 0.50 kg pressed firm tofu, prepared as described in Example 3, was subjected to high-shear homogenizing dispersion using the Silverson L4RT Laboratory Mixer, equipped with the square hole high shear screen with 2 mm holes, at 3000 rpm for 3 minutes, to reduce it to tofu puree. To this tofu puree was added adjunct ingredients, including 16.0 g glycerin, 2.8 g mono- and di-glycerides, and a dry pre-mix comprising 280 g xylitol (supplied by Danisco Canada Inc.), 2.5 g salt, 15.0 g calcium lactate gluconate, 16.0 g inulin (supplied by Orafti Active Food Ingredients, Malvern, Pa.), 38.0 g extra brute cocoa powder (supplied by Barry Callebaut, St. Albans, Vt.), 2.6 g regular non-resistant maltodextrin, 2.0 g guar gum, 1.3 g locust bean gum, 0.9 g carboxymethylcellulose, and 0.4 g carrageenan, and the mixture was subjected to further high-shear homogenizing dispersion at 3000 rpm for an additional 3 minutes, to complete the coarse-mashing step. This high shear operation reduced the tofu in the coarse mash to tofu puree particles, which appeared mostly spheroidal and not exceeding 50 μm in diameter under optical measuring microscopy. The mean particle size, estimated based on Martin's diameter or taken here as the length of the line (in the direction of the horizontal reticle line) dividing the particle area in two equal areas, applied to a total of 625 particles in random fields, was 29 μm. The observation of particle shape and size was made on the spin-dried dispersion on a glass microscope slide, using a Meiji Techno Measuring Microscope MC-40T at 1000 times total magnification with transmitted light from a halogen light source and equipped with an eyepiece micrometer cross-line reticle with 0.1 mm graduations.

### EXAMPLE 6

### Preparation of Coarse Mash Comprising Principally of Tofu Puree from Tofu and Adjunct Ingredients Designated for Aerated “Ice-Cream-Like” Strawberry-Flavored Frozen Desserts

A mixture of tofu varieties, either straight from tofu-making and still warm, or kept at 1 to 4° C. after cooling, comprising 0.95 kg unpressed extra soft silken tofu, prepared as described in Example 2, and 0.66 kg pressed firm tofu, prepared as described in Example 3, was subjected to high-shear homogenizing dispersion using the Silverson L4RT Laboratory Mixer, equipped with the square hole high shear screen with 2 mm holes, at 3000 rpm for 3 minutes, to reduce it to tofu puree. To this tofu puree was added adjunct ingredients, including 60 g strawberry puree (single-strength, seedless, aseptic, supplied by Mondi Foods NV, Rijkevorsel, Belgium), 113 g glycerin, 2.8 g mono- and di-glycerides, and a dry pre-mix comprising 180 g fructose (supplied by Tate & Lyle, Decatur, Ill.), 2.5 g salt, 15.0 g calcium lactate gluconate, 2.6 g regular non-resistant maltodextrin, 2.0 g guar gum, 1.3 g locust bean gum, 0.9 g carboxymethylcellulose, and 0.4 g carrageenan, and the mixture was subjected to further high-shear homogenizing dispersion at 3000 rpm for an additional 3 minutes, to complete the coarse-mashing step. This high shear operation reduced the tofu in the coarse mash to tofu puree particles, which appeared mostly spheroidal and not exceeding 50 μm in diameter under optical measuring microscopy. The mean particle size, estimated based on Martin's diameter or taken here as the length of the line (in the direction of the horizontal reticle line) dividing the particle area in two equal areas, applied to a total of 625 particles in random fields, was 28 μm. The observation of particle shape and size was made on the spin-dried dispersion on a glass microscope slide, using a Meiji Techno Measuring Microscope MC-40T at 1000 times total magnification with transmitted light from a halogen light source and equipped with an eyepiece micrometer cross-line reticle with 0.1 mm graduations.

Generic Step (2): Pasteurization or Sterilization of Coarse Mash:

This is a thermal pasteurization or sterilization step by heating the coarse tofu puree mash to a temperature of at least 82.2° C. for a minimum of 10 seconds, preferably 85° C. for 30 seconds for pasteurization, or, for UHT sterilization, to at least 138° C. for 2 seconds, preferably 140° C. for 4 seconds, not only to make the product safe microbiologically, but also to effectively activate the stabilizer system amongst the adjunct ingredients. On a small scale, this thermal pasteurization or sterilization is simply achieved batch-wise by heating the mash to and holding at pasteurization temperature, with constant stirring, in a stainless steel vessel jacketed by hot water, to achieve the desired results of microbiological safety and stabilizer activation. And the heating temperature is monitored by thermometer. Sterilization, however, is not an option with such a basic setup.

For scaling up to commercial production, a scrape-surface heat-exchanger setup, like that supplied by Invensys APV (Getzville, N.Y.) or Tetra Pak Inc. (Vernon Hills, Ill.), with automated temperature and holding-time controls, is preferred for pasteurizing or sterilizing a mash of thick consistency at a high commercial volume and to achieve long, continuous runs. The option for sterilization opens up the opportunity for eventually packaging the sterilized base mix or finished mix aseptically, like in aseptic bag-in-box, Tetra Pak, or Combibloc containers, for cost-effective, refrigeration-free distribution to franchised premises equipped with suitable freezers, equipment, and materials, for conversion to soft-serves, hard packs, and/or frozen novelties on site.

### EXAMPLE 7

### Pasteurization of Coarse Tofu Puree Mash Designated for Aerated “Ice-Cream-Like” Frozen Desserts

Each coarse tofu puree mash prepared as per Examples 4, 5, and 6, about 2 kg, was put into a stainless steel container and placed in a hot water bath kept at about 90° C. The mash was stirred until the temperature reached 82.2° C., and was held for 30 seconds before transferred to the cooling step.

Generic Step (3): Cooling of Pasteurized or Sterilized Coarse Mash:

On a small scale, this cooling of the pasteurized coarse mash is done by constantly stirring the mash in a stainless steel vessel jacketed by ice water, until the desired temperature of below 10° C., preferably between 1 to 4° C., is reached. And the cooling temperature is monitored by thermometer.

Similar to the pasteurization or sterilization step, for scaling up to commercial production, a scrape-surface heat-exchanger setup, like that supplied by Invensys APV or Tetra Pak Inc., with automated temperature and holding-time controls, is preferred for cooling a mash of thick consistency at a high commercial volume. The benefit of such a setup is that heating and cooling are coupled seamlessly, and with energy regeneration, so important today when energy conservation is such a high priority.

### EXAMPLE 8

### Cooling of Pasteurized Coarse Tofu Puree Mash Designated for Aerated “Ice-Cream-Like” Frozen Desserts

Each coarse tofu puree mash, pasteurized as per Example 7, about 2 kg, in stainless steel container, was placed in an ice water bath kept at close to 0° C. The mash was stirred until the temperature dropped to 1 to 4° C., and then transferred to the aging step.

Generic Step (4): Aging of Pasteurized or Sterilized Coarse Mix:

The pasteurized or sterilized coarse mix, now chilled preferably to between 1 to 4° C., is aged for a minimum of 4 hours, preferably 8 to 12 hours, while being kept cool. This aging maximizes the effectiveness of the hydrocolloids. On a small scale, the batch-pasteurized coarse mix is aged and kept cool in a refrigerator at 1 to 4° C.

For scaling up to commercial production, the pasteurized coarse mix may be aged and kept cool in a chilled or otherwise well-insulated stainless steel tank prior to the “fine” homogenizing dispersion. If the coarse mix is UHT-sterilized and meant subsequently to go into aseptic packaging, the cooled coarse mix may be aged in an insulated aseptic tank. The aseptic tank may be supplied by Niro Soavi (Bedford, N.H.), Invensys APV, or Tetra Pak Inc.

### EXAMPLE 9

### Aging of Cooled, Pasteurized Coarse Tofu Puree Mash Designated for Aerated “Ice-Cream-Like” Frozen Desserts

Each pasteurized coarse tofu puree mash, cooled as per Example 8, about 2 kg, in stainless steel container, was allowed to age for 10 hours in a cooler at 1 to 4° C., before subjected to “fine” homogenizing dispersion. The mash set into a soft-gel-like mass after aging.

Generic Step (5): “Fine” Homogenizing Dispersion for Particle-Size Reduction of Aged Coarse Mash to Base Mix:

The particle-size refining of the aged coarse mash, now set into a soft-gel-like mass, to the base mix is done through a second homogenizing-dispersing operation. While this “fine” homogenizing dispersion may be done through mechanical, sonic, ultrasonic, or any other effective means of homogenizing dispersion, or combination of means thereof, it is preferably done, on a small scale, using a Silverson L4RT “in-tank” top-entry high-shear batch mixer, equipped with square hole high shear screen with 2 mm holes, to effect the desired particle-size reduction of the coarse mash gel to base mix. This powerful mixer assembly, when activated at 4000 rpm or higher, preferably 5000 to 6000 rpm, for 5 minutes or more, preferably for 8 to 10 minutes, is capable of finely homogenizing the dispersion down to the target particle-size range of 0.1 to 27 μm. After the “fine” homogenizing dispersion, the base mix is chilled to 1 to 4° C. for further processing.

For scaling up to commercial production, this “fine” homogenizing dispersion can be done using the Silverson high-shear in-tank top-entry batch mixer equipped with square hole high shear screen, or, even more preferably, the Silverson high-shear in-tank bottom-entry mixer, like the Silverson Disintegrator 2500, equipped with square hole high shear screen, designed to fit into the bottom or side of a mixing vessel, and used in conjunction with a slow speed scraper unit to handle the high viscosity contents. The bottom entry mixer gives high shear homogenization while the scraper distributes the homogenized output uniformly through the vessel. Preferably, the system, whether top-entry or bottom-entry, is coupled with a self-pumping high-shear in-line mixer to ensure complete dispersion before downstream operation. Alternatively, this operation of “fine” homogenizing dispersion can be done through a high-pressure mechanical homogenizer, like that supplied by Niro Soavi, Invensys APV, or Tetra Pak Inc. If aseptic packaging of base mix or finished mix is desired, the mechanical device chosen must be an aseptic homogenizer, like that supplied by Niro Soavi, Invensys APV, or Tetra Pak Inc., installed between the sterilizer and another aseptic tank that immediately precedes the aseptic filling and packaging system. The aseptic filling and packaging system, if aseptic cartons are desired, may be provided by Tetra Pak Inc. or SIG Combibloc Inc. (Chester, Pa.), and if aseptic bag-in-box is desired, by Scholle Packaging (Northlake, Ill.) or Rapak (Romeoville, Ill.)

### EXAMPLE 10

### “Fine” Homogenizing Dispersion of Aged, Pasteurized Coarse Mix Designated for Aerated “Ice-Cream-Like” Vanilla-Flavored Frozen Desserts

A Silverson L4RT “in-tank” top-entry high-shear batch mixer, equipped with square hole high shear screen with 2 mm holes, was sanitized by blending about 2.5 liters of a 100-ppm chlorine sanitizing solution in a 4-liter stainless steel container at 1000 rpm for 1 minute, after which the chlorine solution was discarded. The Silverson assembly was then rinsed, twice, by similarly blending 2.5 liters of previously boiled and cooled water at 1000 rpm for 1 minute and discarding that water. Then the aged, pasteurized coarse mix, prepared as per Example 9, about 2 kg, in a 4-liter stainless steel container, was subjected to “fine” homogenizing dispersion using the pre-sanitized Silverson mixer, at 5000 rpm for 8 minutes. This high shear operation reduced the principally tofu puree particles in the coarse mash to fine particles which appeared mostly spheroidal and not exceeding 30 μm in diameter under optical measuring microscopy. The mean particle size, estimated based on Martin's diameter or taken here as the length of the line (in the direction of the horizontal reticle line) dividing the particle area in two equal areas, applied to a total of 625 particles in random fields, was 16 μm. The observation of particle shape and size was made on the spin-dried dispersion on a glass microscope slide, using a Meiji Techno Measuring Microscope MC-40T at 1000 times total magnification with transmitted light from a halogen light source and equipped with an eyepiece micrometer cross-line reticle with 0.1 mm graduations.

### EXAMPLE 11

### “Fine” Homogenizing Dispersion of Aged, Pasteurized Coarse Mix Designated for Aerated “Ice-Cream-Like” Chocolate-Flavored Frozen Desserts

A Silverson L4RT “in-tank” top-entry high-shear batch mixer, equipped with square hole high shear screen with 2 mm holes, was sanitized by blending about 2.5 liters of a 100-ppm chlorine sanitizing solution in a 4-liter stainless steel container at 1000 rpm for 1 minute, after which the chlorine solution was discarded. The Silverson assembly was then rinsed, twice, by similarly blending 2.5 liters of previously boiled and cooled water at 1000 rpm for 1 minute and discarding that water. Then the aged, pasteurized coarse mix, prepared as per Example 9, about 2 kg, in a 4-liter stainless steel container, was subjected to “fine” homogenizing dispersion using the pre-sanitized Silverson mixer, at 5000 rpm for 8 minutes. This high shear operation reduced the principally tofu puree particles in the coarse mash to fine particles which appeared mostly spheroidal and not exceeding 30 μm in diameter under optical measuring microscopy. The mean particle size, estimated based on Martin's diameter or taken here as the length of the line (in the direction of the horizontal reticle line) dividing the particle area in two equal areas, applied to a total of 625 particles in random fields, was 17 μm. The observation of particle shape and size was made on the spin-dried dispersion on a glass microscope slide, using a Meiji Techno Measuring Microscope MC-40T at 1000 times total magnification with transmitted light from a halogen light source and equipped with an eyepiece micrometer cross-line reticle with 0.1 mm graduations.

### EXAMPLE 12

### “Fine” Homogenizing Dispersion of Aged, Pasteurized Coarse Mix Designated for Aerated “Ice-Cream-Like” Strawberry-Flavored Frozen Desserts

A Silverson L4RT “in-tank” top-entry high-shear batch mixer, equipped with square hole high shear screen with 2 mm holes, was sanitized by blending about 2.5 liters of a 100-ppm chlorine sanitizing solution in a 4-liter stainless steel container at 1000 rpm for 1 minute, after which the chlorine solution was discarded. The Silverson assembly was then rinsed, twice, by similarly blending 2.5 liters of previously boiled and cooled water at 1000 rpm for 1 minute and discarding that water. Then the aged, pasteurized coarse mix, prepared as per Example 9, about 2 kg, in a 4-liter stainless steel container, was subjected to “fine” homogenizing dispersion using the pre-sanitized Silverson mixer, at 5000 rpm for 8 minutes. This high shear operation reduced the principally tofu puree particles in the coarse mash to fine particles which appeared mostly spheroidal and not exceeding 30 μm in diameter under optical measuring microscopy. The mean particle size, estimated based on Martin's diameter or taken here as the length of the line (in the direction of the horizontal reticle line) dividing the particle area in two equal areas, applied to a total of 625 particles in random fields, was 16 μm. The observation of particle shape and size was made on the spin-dried dispersion on a glass microscope slide, using a Meiji Techno Measuring Microscope MC-40T at 1000 times total magnification with transmitted light from a halogen light source and equipped with an eyepiece micrometer cross-line reticle with 0.1 mm graduations.

Generic Step (6): Finishing by Adding Flavoring(s), Acidulant(s), and/or Coloring(s) to Convert Base Mix to Finished Mix, if Necessary:

Tofu is noted for its blandness. Frozen desserts comprising principally of tofu puree will taste bland unless some characterizing flavor is blended into the base mix. For example, dark cocoa powder, green tea, almonds, strawberries, or blueberries may form part of the adjunct ingredients to give the resulting frozen dessert a characterizing flavor. And in most cases, the product flavor is further enhanced by incorporating one or more food flavoring(s), preferably natural flavoring(s), to round up the overall flavor impact, or to inject the desired “top notes” or complementary flavor(s). For example, a natural mint flavoring is added to a dark-cocoa base mix to produce a dark chocolate mint finished mix, a natural vanilla flavoring is added to round up the harsh taste of a dark chocolate finished mix, and a natural strawberry flavoring is added to a strawberry base mix to enhance the top notes of the strawberry-flavored frozen dessert.

For fruit-flavored frozen desserts, one or more acidulants, like citric acid, or other food-grade acids, may be added to boost the fruity taste.

In some cases, food coloring material(s), preferably natural coloring material(s), may be necessary to improve the esthetic attractiveness of the frozen dessert. For example, a natural red beet colorant is used to enhance the color of the strawberry-flavored frozen dessert comprising tofu puree.

Liquid flavorings, acidulant solutions, and/or coloring solutions are preferred for ease of homogeneous blending, and, if an aseptic finished mix is desired, adaptability to microfiltration aseptic dosing. Aseptic dosing equipment may be supplied by Tetra Pak Inc.

At the stage of base mix or finished mix, the refrigerated, pasteurized product may be packaged for eventual freezing elsewhere into the finished frozen dessert. Whereas the sterilized product, if aseptically handled throughout after sterilization, also lends itself to aseptic packaging into aseptic cartons like those of Tetra Pak or SIG Combibloc, or aseptic bag-in-box like that of Scholle Packaging or of Rapak. The aseptically-packed base can then be shipped without the need for refrigeration to licensed locations equipped with proper freezers, equipment, and materials, for conversion into soft-serves, hard packs, and/or frozen novelties on premise.

### EXAMPLE 13

### Finishing of Finely-Homogenized Base Mix Designated for Aerated “Ice-Cream-Like” Vanilla-Flavored Frozen Desserts

The finely-homogenized base mix, prepared as per Example 10, about 2 kg, was converted to finished mix by stirring into it 12 ml of Natural Vanilla Flavor (supplied by Givaudan Flavors, Bridgeton, Mo.). The finished mix was kept at 1 to 4° C. before freezing into frozen dessert.

### EXAMPLE 14

### Finishing of Finely-Homogenized Base Mix Designated for Aerated “Ice-Cream-Like” Chocolate-Flavored Frozen Desserts

The finely-homogenized base mix, prepared as per Example 11, about 2 kg, was converted to finished mix by stirring into it 2 ml of Natural Chocolate Flavor and 5 ml of Natural Vanilla Flavor (both supplied by Givaudan Flavors, Bridgeton, Mo.). The finished mix was kept at 1 to 4° C. before freezing into frozen dessert.

### EXAMPLE 15

### Finishing of Finely-Homogenized Base Mix Designated for Aerated “Ice-Cream-Like” Strawberry-Flavored Frozen Desserts

The finely-homogenized base mix, prepared as per Example 12, about 2 kg, was converted to finished mix by stirring into it 3.0 g of a 50%-solution of citric acid (anhydrous, supplied by Tate & Lyle, Decatur, Ill.), 1 ml of Red Beet Natural Colorant (supplied by D. D. Williamson, Louisville, Ky.), and 5 ml of Natural Strawberry Flavor (supplied by Givaudan Flavors, Bridgeton, Mo.). The finished mix was kept at 1 to 4° C. before freezing into frozen dessert.

Generic Step (7): Freezing of Base Mix or Finished Mix with Aeration to Achieve an “Ice-Cream-Like” Texture with Overrun, Folding in Mix-Ins or Bulky Inclusions where Desired; and Soft-Serving the Product without Hardening, for Immediate Consumption on-Premise; or Packaging and Hardening the Product for Subsequent Storage, Distribution, and Consumption:

The cooled finished mix is now ready for freezing with aeration into “ice-cream-like” frozen dessert, whether for soft-serving on premise, depositing into molds or receptacles for novelties, or hardening into hard-pack. The aeration can be done immediately prior to or simultaneously with the freezing operation, and is preferably done simultaneously and conveniently in a dasher-equipped freezer. On a small scale, for the on-premise soft-serve approach, a countertop batch-type soft-serve machine like the model UC-711 by Carpigiani (supplied by Carpigiani Corporation of America, Winston-Salem, N.C.), is preferred, and the product is drawn at about −7 to −8° C. For the hard-pack or frozen novelty approach, a batch-type ice-cream freezer, like the model LB-1002 by Carpigiani, is preferred, and the product is drawn at about −3 to −4° C. The subsequent hardening of the filled packs or deposited novelties, at −40° C., is done in a flash hardener, like that by Kelvinator (supplied by National Consolidated Industries, Inc., Honea Path, S.C.). The hard-pack or frozen novelty approach also lends itself to mix-ins or bulky inclusions, like dark chocolate chips or chunks, fruit pieces like pineapple tidbits, or nuts like walnuts or almonds, being folded in while the frozen mass drawn from the freezer is still pliable. The hardened packs and frozen novelties are stored in storage freezers kept at −18° C. or below, preferably at about −25° C., until consumption.

For the scaled-up commercial production of soft-serves on premise, a floor machine like the Carpigiani UF-820 E is preferred.

For scaling up to the commercial production of hard-packs or frozen novelties, a continuous freezer coupled to a downstream system comprising filling and packaging, hardening, and frozen storage, like the equipment by Hoyer (supplied by Tetra Pak Hoyer, Lake Geneva, Wis.), is preferred.

The frozen desserts comprising principally of tofu puree have a gelato-like texture and exhibit excellent flavor and physical stability during proper frozen storage, and command at least a 6-month shelf life in frozen storage at −25° C.

### EXAMPLE 16

### Freezing of Finished Mix Designated for Aerated “Ice-Cream-Like” Vanilla-Flavored Frozen Desserts

The finished mix, prepared as per Example 13, about 10 kg, was fed into a batch-type ice-cream freezer, like the Carpigiani-Coldelite Model LB-1002, and set to freeze for about 4.5 minutes, after which the semi-frozen mass was dispensed into lidded one-liter containers. The overrun was about 28%. The containers were hardened in a flash hardener, like that supplied by Kelvinator, to a temperature of −40° C. After hardening, the containers were stored in a storage freezer, like that supplied by Kelvinator, at a temperature around −25° C., until evaluation time.

### EXAMPLE 17

### Freezing of Finished Mix Designated for Aerated “Ice-Cream-Like” Chocolate-Flavored Frozen Desserts

The finished mix, prepared as per Example 14, about 10 kg, was fed into a batch-type ice-cream freezer, like the Carpigiani-Coldelite Model LB-1002, and set to freeze for about 4.5 minutes, after which the semi-frozen mass was dispensed into lidded one-liter containers. The overrun was about 25%. The containers were hardened in a flash hardener, like that supplied by Kelvinator, to a temperature of −40° C. After hardening, the containers were stored in a storage freezer, like that supplied by Kelvinator, at a temperature around −25° C., until evaluation time.

### EXAMPLE 18

### Freezing of Finished Mix Designated for Aerated “Ice-Cream-Like” Strawberry-Flavored Frozen Desserts

The finished mix, prepared as per Example 15, about 10 kg, was fed into a batch-type ice-cream freezer, like the Carpigiani-Coldelite Model LB-1002, and set to freeze for about 4.5 minutes, after which the semi-frozen mass was dispensed into lidded one-liter containers. The overrun was about 25%. The containers were hardened in a flash hardener, like that supplied by Kelvinator, to a temperature of −40° C. After hardening, the containers were stored in a storage freezer, like that supplied by Kelvinator, at a temperature around −25° C., until evaluation time.

The frozen desserts prepared as per Examples 16, 17, and 18 were subjected to a scoring preference test by a taste panel made up of 25 panelists, all regular consumers of soy foods and liking frozen desserts, against comparable flavors of commercial soy frozen dessert brands, namely, So Good®, So Delicious®, and Purely Decadent®, all bought at retail. So Good® is a registered trademark of SoyaWorld Inc., Vancouver, B. C., Canada, and its soy frozen dessert products are made primarily with isolated protein, without tofu. On the other hand, So Delicious® and Purely Decadent® are registered trademarks of Turtle Mountain LLC, Eugene, Oreg.; both their branded lines of soy frozen dessert products are made primarily with organic soymilk, again without tofu. Panelists, pre-screened as consuming soy foods regularly (at least once a month) and liking frozen desserts, were each seated individually in a partitioned booth and each presented with a score sheet and pen and a tray holding four frozen dessert samples of the same described flavor in randomly numbered 2-oz paper cups with taster spoons, a glass of water for rinsing in-between samples, and an empty glass to hold rinse wastes. The four samples comprised the three said commercial brands of the same described flavor, and the corresponding test sample of this invention prepared as per Example 16, 17, or 18, all blind to the panelists, and were randomly sequenced in the order of presentation. The panelists were asked to taste the samples, rinse the palate in-between samples, and check against a liking statement against each sample number on a score sheet. The liking statements were based on a 9-point hedonic scale verbalized as “Like Extremely,” “Like Very Much,” “Quite Like It,” “Somewhat Like It,” “Neither Like Nor Dislike,” “Somewhat Dislike It,” “Quite Dislike It,” “Dislike Very Much,” and “Dislike Extremely,” translated to a numerical score stepwise from 9 to 1, in descending order respectively, in eventual data analysis. The preference scores were subjected to one-way analysis of variance, followed by post hoc analysis using Tukey's HSD. The results, summarized in Tables 1, 2, and 3, clearly indicated the liking viability of the three flavors of frozen desserts comprising principally of tofu puree prepared as per Examples 16, 17, and 18 described in this invention, as compared with the same described flavors of the commercial brands:

TABLE 1
One-Way Analysis of Variance on Hedonic Preference Scores
of Vanilla-Flavored Soy Frozen Desserts:
SUMMARY

| Groups | Count | Sum | Average | Variance |
|---|---|---|---|---|
| So Good ® | 25 | 129 | 5.16 | 0.47 |
| So Delicious ® | 25 | 136 | 5.44 | 0.42 |
| Purely Decadent ® | 25 | 161 | 6.44* | 0.59 |
| “This Invention” | 25 | 155 | 6.20* | 0.42 |

ANOVA

| Source of Variation | SS | df | MS | F | P-value | F crit |
|---|---|---|---|---|---|---|
| Between Groups | 27.71 | 3 | 9.24 | 19.41 | 6.4E−10 | 2.70 |
| Within Groups | 45.68 | 96 | 0.48 | | | |
| Total | 73.39 | 99 | | | | |

*No significant difference between these two means by Tukey's HSD, at p = 0.05

TABLE 2
One-Way Analysis of Variance on Hedonic Preference Scores
of Chocolate-Flavored Soy Frozen Desserts:
SUMMARY

| Groups | Count | Sum | Average | Variance |
|---|---|---|---|---|
| So Good ® | 25 | 141 | 5.64 | 0.82 |
| So Delicious ® | 25 | 148 | 5.92 | 0.66 |
| Purely Decadent ® | 25 | 178 | 7.12* | 0.61 |
| “This Invention” | 25 | 182 | 7.28* | 0.54 |

ANOVA

| Source of Variation | SS | df | MS | F | P-value | F crit |
|---|---|---|---|---|---|---|
| Between Groups | 51.71 | 3 | 17.24 | 26.15 | 1.9E−12 | 2.70 |
| Within Groups | 63.28 | 96 | 0.66 | | | |
| Total | 114.99 | 99 | | | | |

*No significant difference between these two means by Tukey's HSD, at p = 0.05

TABLE 3
One-Way Analysis of Variance on Hedonic Preference Scores
of Strawberry-Flavored Soy Frozen Desserts:
SUMMARY

| Groups | Count | Sum | Average | Variance |
|---|---|---|---|---|
| So Good ® | 25 | 147 | 5.88 | 0.44 |
| So Delicious ® | 25 | 131 | 5.24 | 0.52 |
| Purely Decadent ® | 25 | 173 | 6.92* | 0.41 |
| “This Invention” | 25 | 187 | 7.48* | 0.68 |

ANOVA

| Source of Variation | SS | df | MS | F | P-value | F crit |
|---|---|---|---|---|---|---|
| Between Groups | 76.28 | 3 | 25.43 | 49.53 | 2E−19 | 2.70 |
| Within Groups | 49.28 | 96 | 0.51 | | | |
| Total | 125.56 | 99 | | | | |

*Significant difference between these two means by Tukey's HSD, at p = 0.05

The caloric values of the test-sample frozen desserts prepared in Examples 16, 17, and 18 were compared against those of comparable flavors of commercial soy frozen dessert brands, namely, So Good®, So Delicious®, and Purely Decadent®, in Table 4. Obviously, the products as per Examples 16, 17, and 18 described in this invention were more than 25% lower in calories compared with any of the reference products of the same flavor, or compared with the average of the same flavor of the three commercial brands.

TABLE 4
Caloric Values of Vanilla-Flavored, Chocolate-Flavored, and
Strawberry-Flavored Frozen Desserts of Various Soy Brands:
Soy Frozen Dessert

| | Calories per 100 g | | |
|---|---|---|---|
| | Vanilla- | Chocolate- | Strawberry- |
| Description | Flavored | Flavored | Flavored |
| So Good ® | 150 | 177 | 150 |
| So Delicious ® | 160 | 160 | 148 |
| Purely Decadent ® | 170 | 210 | 170 |
| Average of 3 Brands | 160 | 182 | 156 |
| “This Invention” | 95 | 90 | 108 |

The nutrition-related attributes of the test-sample frozen dessert products prepared as per Examples 16, 17, and 18 described in this invention were compared against the nutrition-related objectives defined earlier in paragraph [0022], and are summarized in Table 5 as follows:

TABLE 5
Summary of Nutrition-Related Attributes of Vanilla-Flavored,
Chocolate-Flavored, and Strawberry-Flavored Frozen Desserts
Prepared as per Examples 16, 17, and 18 of This Invention:

| | Nutrition-Related Attribute Figures of Frozen Desserts | | | |
|---|---|---|---|---|
| Nutrition-Related | Object | Vanilla- | Chocolate- | Strawberry- |
| Attributes | Requirement | Flavored | Flavored | Flavored |
| Tofu Puree, % | More than 80 | 87.1 | 81.0 | 80.5 |
| Calorie | 25 or more | 40.6 | 50.6 | 30.8 |
| Reduction, %* | | | | |
| Sodium, | 140 or less | 105 | 106 | 104 |
| mg/100 g | | | | |
| Calcium, | 300 or more | 360 | 353 | 363 |
| mg/100 g | | | | |
| Cholesterol, | 20 or less | 0 | 0 | 0 |
| mg/100 g | | | | |
| Saturated Fat, | 1 or less | 0.6 | 0.8 | 0.6 |
| g/100 g | | | | |
| Calories from | 15 or less | 5.2 | 7.6 | 4.6 |
| Saturated Fat, % | | | | |
| Fat, | 3 or less | 2.6 | 2.8 | 2.6 |
| g/100 g | | | | |
| Calories from Fat, | 30 or less | 24.5 | 28.4 | 21.9 |
| % | | | | |
| Protein, | 5 or more | 5.0 | 5.0 | 5.0 |
| g/100 g | | | | |

*Caloric comparison made against the average of the same flavor of three commercial soy frozen dessert brands including So Good ®, So Delicious ®, and Purely Decadent ®

### CONCLUSION

By the results presented in Tables 1, 2 and 3, because the test-sample frozen desserts pertaining to this invention were rated with definitely positive liking scores either at par with or significantly better than the corresponding versions of the top commercial brands of soy frozen desserts, it would be safe to conclude that the frozen desserts so prepared according to this invention were enjoyable. And by the results presented in Tables 4 and 5, because the test-sample frozen desserts pertaining to this invention appeared to have met all nutritional-related attribute expectations as stated in paragraph [0022], it would be safe to conclude that the frozen desserts so prepared according to this invention were healthy. Hence, it would appear appropriate to conclude that the aerated frozen desserts so prepared, comprising more than eighty percent tofu puree, were indeed healthy and enjoyable, as per the stated object of this invention.

What is claimed is:

1. Aerated frozen desserts, comprising more than 80.0 percent, preferably 80.5 to 87.1 percent, by weight of tofu puree, containing particles.

2. The aerated frozen desserts of claim 1, which contain 3 grams or less of fat per 100 grams of product.

3. The aerated frozen desserts of claim 1, which contain 130 or fewer Calories per 100 grams of product.

4. The aerated frozen desserts of claim 1, which contain 140 milligrams or less of sodium per 100 grams of product.

5. The aerated frozen desserts of claim 1, which contain 300 milligrams or more of calcium per 100 grams of product.

6. The aerated frozen desserts of claim 1, which contain 1 gram or less of saturated fat per 100 grams of product.

7. The aerated frozen desserts of claim 1, which contain 20 milligrams or less of cholesterol per 100 grams of product.

8. The aerated frozen desserts of claim 1, which contain 5 grams or more of soy protein per 100 grams of product, without additionally requiring the use of isolated soy protein or any other soy-protein-containing material.
